(19) United States
(12) Patent Application Publication
(10) Pub. No.: US 2015/0266711 A1
(43) Pub. Date: Sep. 24, 2015

(54) FILLING UNIT FOR FILLING CONTAINERS WITH POURABLE PRODUCTS

(71) Applicant: Sidel S.p.A., Parma (IT)

(72) Inventors: Roberto ZONI, Parma (IT); Annalisa MALFATTO, Parma (IT); Vincenzo GALOTTO, Parma (IT)

(73) Assignee: Sidel S.p.A.

(21) Appl. No.: 14/638,249

(22) Filed: Mar. 4, 2015

(30) Foreign Application Priority Data
Mar. 18, 2014 (EP) 14160609.5

(51) Int. Cl. B67C 7/00

(52) U.S. Cl. CPC B67C 7/004; B67C 7/008; B67C 2007/006

(57) ABSTRACT

A filling unit is disclosed. The filing unit includes a tubular body defining an axial passage for fluids and delimiting at one end a delivery mouth; a first fluidic line including the entire passage of the tubular body and fed in use with a cleaning liquid; a second fluidic line, which includes a portion of the axial passage and which is fed in use with the pourable product or the cleaning liquid; a shutter housed within the passage and selectively moved to open or to close the delivery mouth; and an electromagnetic actuator for moving the shutter and having an external stator, and a movable element connected to the shutter and coaxially housed inside the passage so as to allow a fluid flow through the passage.

### TECHNICAL FIELD

The present invention relates to a filling unit for filling containers with pourable products, in particular of the type requiring to be handled in aseptic conditions.

The present invention may be used to particular advantage for pourable food products, such as high-viscosity liquids or liquid products with particles, i.e. solid parts immersed in the liquid; typical examples of this latter type of pourable product are soft drinks or beverages containing fruit particles, such as soft fruit bits, fruit fibers and fruit sacs.

### BACKGROUND ART

A typical known filling machine used for this kind of pourable products substantially comprises a carousel rotating about an axis, a product tank containing the pourable product and carried centrally by the carousel, and a plurality of filling units supported by the carousel in positions radially external with respect to the product tank, connected to the product tank through respective fluidic lines and conveyed by the carousel along a circular transfer path.

In particular, the carousel receives a succession releases the filled containers to an output star wheel.

Each filling unit basically comprises a support device, adapted to receive and retain a respective container in a vertical position, and a filling device for feeding a given volume of pourable product into the container as the support device travels along the circular transfer path. In particular, the filling device comprises means for measuring out a given volume of pourable product coming from the product tank and for feeding it to the respective container.

As known, the handling of certain types of pourable food products requires to operate in aseptic conditions. This means that the zone of the machine destined to perform the operations on the containers has to be isolated from the rest of the machine and maintained in conditions of sterility.

In addition, all devices or parts of the machine used to cooperate with the pourable product, e.g. the devices used for controlling the flow rate of the pourable product, must be designed so that they can be easily cleaned up; this means that all these devices are required to not possess any complicatedly formed. passage, pocket or other spaces difficult to clean by means of a cleaning liquid.

In practice, the flow path of the pourable product not only has to be completely sealed off towards the non-sterile environment, but it also has to be immaculate from a point of view of hygiene, that is to say it should be simple to wash and to sterilize.

In order to maintain a complete separation between the part, of the filling unit cooperating with the pourable product and the non-sterile environment, it is known the use of electromagnetic actuators; these actuators typically have the electrically-powered stator part housed in the non-sterile environment and a movable element directly cooperating with the pourable product and adapted to be cleaned up between two successive production steps.

This kind of actuators has the drawback to be easily subjected to excessive overheating during operation, is therefore necessary to provide additional cooling means to cool them periodically, with a consequent increase of costs and complexity, of the filling machine.

The above need also contrasts with another need particularly felt in this field, i.e. to reduce energy consumptions.

### DISCLOSURE OF INVENTION

It is therefore an object of the present invention to provide a filling unit for filling a container with a. pourable product, which is designed to overcome the aforementioned drawbacks and to meet at least one of the previously indicated needs.

According to the present invention, there is provided a filling unit for filling a container with a pourable product, as claimed in claim 1.

### BRIEF DESCRIPTION OF THE DRAWINGS

Two preferred non-limiting embodiments of the present invention will be described by way of example with reference to the accompanying drawings, in which:

FIG. 1 shows a front view, with parts removed for clarity, of a filling machine provided with a plurality of filling units according to the present invention;

FIG. 2 shows a larger-scale, axial section of one filling unit of the FIG. 1 filling machine along with part of a product tank and other components of such machine;

FIG. 3 shows a larger-scale section along line III-III of FIG. 2;

FIG. 4 shows a larger-scale section along line IV-IV of FIG. 2;

FIG. 5 shows a larger-scale detail of FIG. 2;

FIGS. 6 and 7 show larger-scale axial sections of the FIG. 2 filling unit in different operating conditions; and

FIGS. 8 to 10 show larger-scale axial sections of a different embodiment of a filling unit according to the present invention, in different operating conditions

### BEST MODE FOR CARRYING OUT THE INVENTION

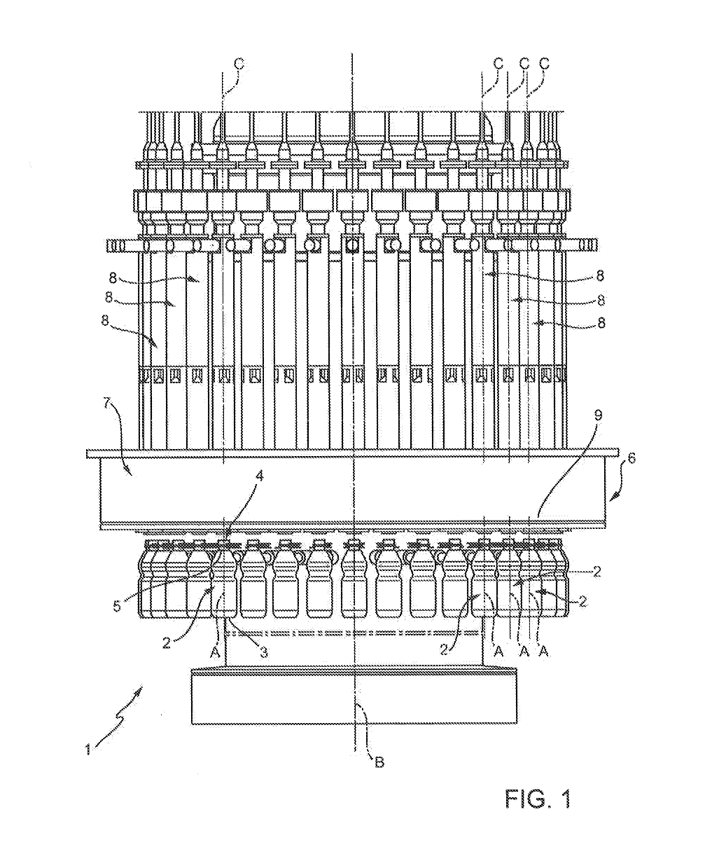

Number 1 in FIG. 1 indicates as a whole a filling machine to fill containers, in particular bottles 2, in aseptic conditions with a pourable food product, such as a high viscosity liquid or a liquid product with particles, i.e. solid parts immersed in the liquid; typical examples of this latter pourable food product are soft drinks or beverages containing fruit particles, such as soft fruit bits, fruit fibers and fruit sacs.

Machine 1 is clearly also adapted to fill bottles 2 with other types of pourable food products, such as milk, still water, carbonated water, fruit juices, beer, soft drinks and beverages in general. Machine 1 is also adapted to fill bottles 2 with emulsions and suspensions.

As visible in particular in FIGS. 1, 2, 5 and 6, each bottle 2 has a longitudinal axis A and comprises:
a bottom wall 3 substantially perpendicular to axis A;
a mouth 4, opposite to bottom wall 3, to allow the filling of the bottle 2 by machine and the following pouring of the pourable product from the bottle 2 itself; and
a neck 5 arranged immediately below mouth 4.

In the example shown, bottles are made of plastics; however, machine 1 may be also used for other types of containers, such as containers made of aluminum, steel, glass and composites.

Machine 1 comprises a conveying device 6 (FIG. 1) that serves to fill bottles 2 while they are conveyed along a transfer path P.

In the preferred embodiment as illustrated in FIG. 1, conveying device 6 comprises a carousel 7 which is mounted to rotate continuously (anticlockwise in FIG. 1) about a vertical axis B.

Carousel 7 receives a succession of empty bottles 2 from an input star wheel (known per se and not shown); and releases a succession of filled bottles 2 to an output star wheel (also known per se and not shown); both input and output star wheels rotate continuously about respective longitudinal axes parallel to axis B.

Machine 1 further comprises a plurality of filling units 8 for filling respective bottles 2 while they are advanced by carousel 7. Filling units 8 are equally spaced angularly about axis B and are mounted along a peripheral portion 9 of carousel 7. Filling units 8 have respective axes C parallel to axis B and are moved by carousel 7 along path P; in the present case, path P has a circular configuration about axis B.

Machine 1 also includes a product tank 10 common to all filling units 8 and which is filled with the pourable product at a given pressure value. Tank 10 is normally arranged centrally on carousel 7.

As filling units 8 are identical to one another, only one will be described hereafter for the sake of simplicity; it is however clear that the following description will apply to any filling unit 8.

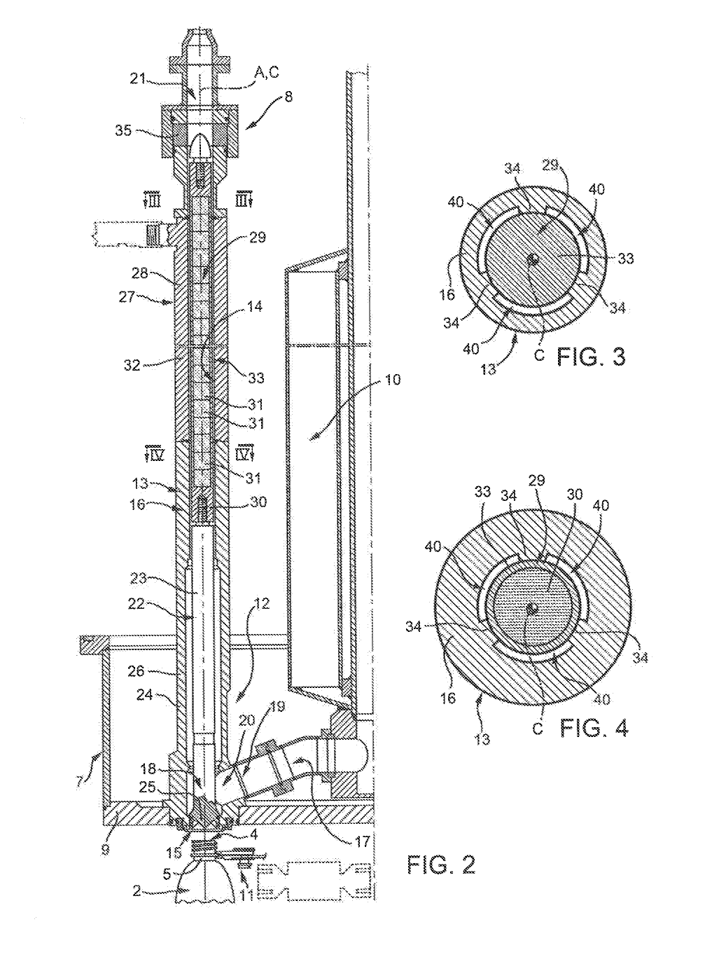

As shown in particular in FIGS. 2, 5, 6 and 7, filling unit 8 comprises a support device 11, adapted to receive and retain one bottle 2 in a vertical position, in which such bottle 2 has its axis A coaxial with axis C and parallel to axis B of carousel 7; filling unit 8 also comprises a filling device 12 for feeding the pourable product into a relative bottle 2 as the support device 11 travels along path P.

Filling device 12 is conveniently arranged coaxially with axis C and above the bottle 2 to be filled.

Filling device 12 basically comprises a vertical tubular body 13 coaxial with axis C, defining an axial passage 14 for fluids and delimiting, at its bottom end, a delivery mouth 15, through which the pourable product coming from tank 10 is fed to bottle 2.

In particular, tubular body 13 has a cylindrical lateral wall 16 delimiting internally passage 14.

Filling device 12 further comprises a fluidic line 17 connecting a bottom portion of tank 10 to a bottom portion 18 of passage 14 adjacent to delivery mouth 15; an on/off valve (known per se and not shown), arranged along fluidic line 17, controls supply of the pourable product from tank 10 to the fluidic line 17 itself.

In view of the above, fluidic line 17 is therefore formed by bottom portion 18 of passage 14 and by a conduit 19 extending transversally to tubular body 13 and connecting passage 14 to tank 10. In particular, conduit 19 communicates with passage 14 by means of a radial through hole 20 formed. into lateral wall 16 of tubular body 13. Bottom portion 18 is therefore defined by the portion of passage 14 comprised between delivery mouth 15 and hole 20.

The entire passage 14 is also part of another fluidic line 21, fed in use with one or more cleaning liquids—i.e. a washing liquid, a sanitization liquid and a rinsing liquid—to clean periodically all parts of the machine cooperating with the pourable product.

As it will explained hereafter, during the cleaning operation, cleaning liquids are also fed through fluidic line 17.

As a possible alternative not shown, the entire passage 14 may be directly connected at the top to tank 10; in this way, both the pourable product and the cleaning liquids would flow through the entire passage 14 of tubular body 13 in different operating steps of machine 1.

Filling unit 8 further comprises a shutter 22 housed within passage 14 and which is selectively moved to open or to close, in a fluid-tight manner, delivery mouth 15.

In particular, shutter 22 is defined by a plunger 23 housed with radial play within a bottom portion 24 of lateral wall 16 of tubular body 13 and having a conical bottom head 25 adapted to cooperate with delivery mouth 15 to close it in a fluid-tight manner.

More specifically, delivery mouth 15 is defined by a restricted-section end of passage 14 having a complementary profile to that of head 25 of shutter 22.

As illustrated in FIGS. 2, 6 and 7, bottom portion 24 of lateral wail 16 of tubular body 13 presents a bottom length 26 having an enlarged inner diameter than the rest of the lateral wall 16. Bottom length 26 ends with restricted-section end of delivery mouth 15.

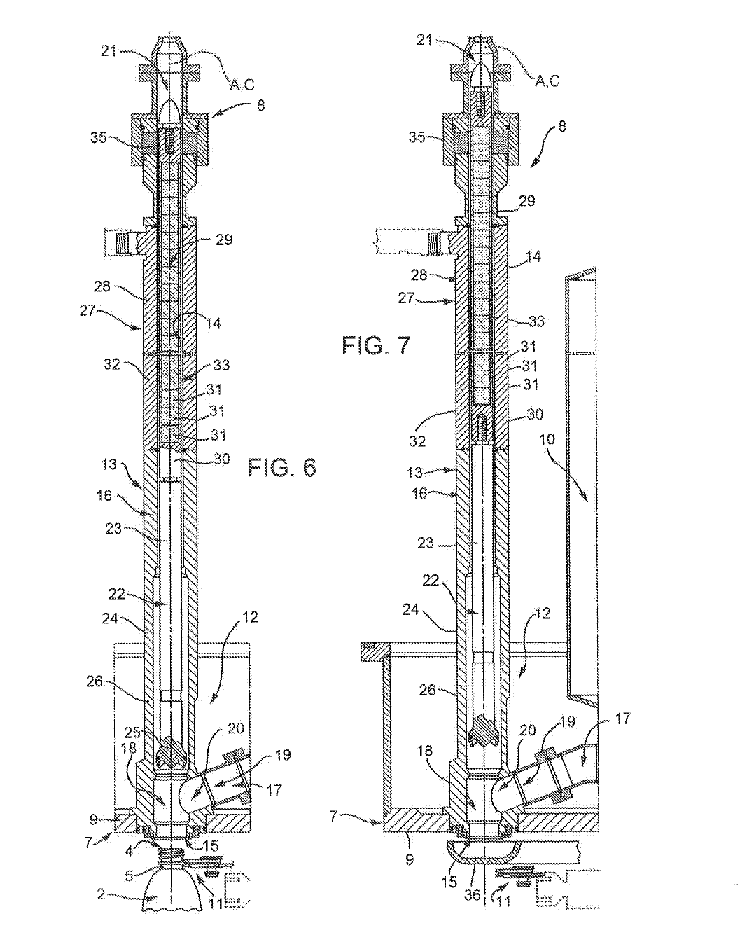

Filling unit 8 further comprises an electromagnetic actuator 27 for axially displacing shutter 22 so as to close or to open delivery mouth 15; in the closing configuration (FIG. 2), head 25 of shutter 22 cooperates in a fluid-tight manner with delivery mouth 15; in the opening configuration (FIGS. 6 and 7), head 25 of shutter 22 is axially detached from delivery mouth 15.

Actuator 27 comprises a stator 23, fitted externally to tubular body 13 and provided with electrically-powered coils (known per se and not shown), and a movable element 29 carrying, at one end 30, shutter 22, housed inside passage 14 of tubular body 13 and provided with a plurality of permanent magnets 31.

In particular, stator 28 defines a top portion 32 of lateral wall 16 of tubular body 13; movable element 29 is defined by a plunger 33 internally housing magnets 31 and directly coupled, at its end 30, to plunger 23 of shutter 22.

Movable element 29 has an outer diameter, which is a few percent lower than the inner diameter of passage of tubular body 13, so that, during a cleaning operation of filling unit 8, cleaning liquids can flow between movable element 29 and tubular body 13. To further ease this flow, tubular body 13 is internally provided with a plurality of longitudinal teeth 34 (see FIGS. 3 and 4), in the example shown three, which are equally spaced angularly about axis C and cooperate in a sliding manner with outer surface of movable element 29; teeth 34, the inner surface of tubular body 13 between. each pair of teeth 34 and the outer surface of movable element 29 delimit a plurality of longitudinal gaps 40, which are equally spaced angularly about axis C and allow in use flow of cleaning liquids.

By controlling excitation of coils of stator 28, movable element 29 can be displaced into a first axial position (FIG. 2), in which it maintains shutter 22 in the closing configuration on delivery mouth 15, and in a second axial position (FIG. 6), in which it maintains head 25 of shutter 22 detached from delivery mouth 15 of a given amount so allowing the pourable product or the cleaning liquids to flow through the delivery mouth 15 itself.

In particular, in the second axial, position. (FIG. 6), head 25 of shutter 22 is positioned above hole 20 from which conduit 19 extends.

With reference to FIGS. 2, 6 and 7, filling unit 8 further comprises a non-powered, ring-shaped, magnetic attraction element 35 fitted to tubular body 13 in an axially-spaced relationship with stator 28 and exerting an attraction force on movable element 29, as engaged. by the latter, to maintain the movable element 29 in a third axial position (FIG. 7), distinct from the first and second axial position and in which the movable element 29 maintains shutter 22 detached from delivery mouth 15.

In particular, magnetic attraction element 35 is arranged on the opposite side of stator 28 with respect to delivery mouth 15; hence, in the third axial position (FIG. 7), movable element 29 is raised with respect to the second axial position (FIG. 6) and has its head 25 detached from delivery mouth 15 of a greater distance than in the second axial position. In other words, the second axial position of movable element 29 is interposed between the first and the third axial position.

Magnetic attraction element 35 is adapted to maintain the movable element 29 in the third axial position independently of powering stator 28.

Magnetic attraction element 35 may be made of a ferromagnetic material, may include a permanent magnet or even may be a combination thereof, depending on the required attraction force.

Movable element is displaced into the third axial position (FIG. 7) during the cleaning operation on filling unit 8. In this way, is possible to drastically reduce electricity consumption and excessive warming of actuator 27.

Operation of machine 1 will now be described with reference to the filling of one bottle 2, and therefore to one filling unit 8 and as of the instant in which such bottle 2 is received by support device 11 of filling unit 8 from the input star wheel in order to be filled with the pourable product.

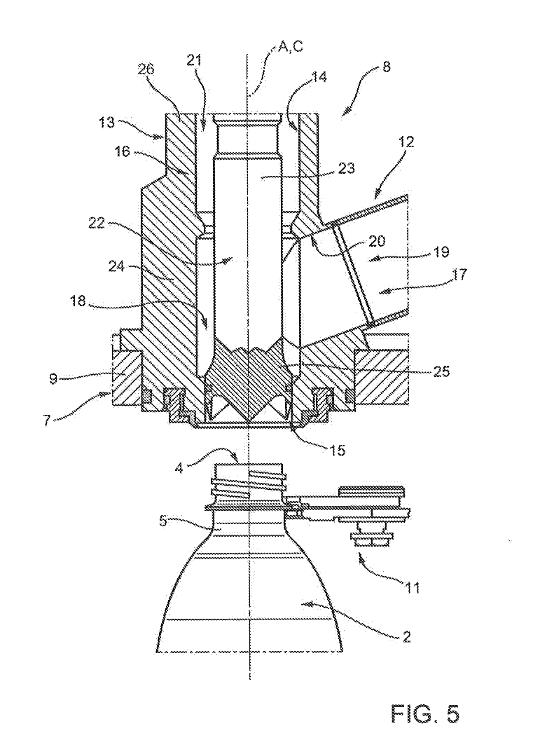

In particular (FIGS. 2 and 5), bottle 2 is centered in known manner with respect to filling unit 8, the valve on conduit 19 is closed and movable element 29 of actuator 27 in the first axial position and maintains shutter 22 in the closed configuration on delivery mouth 15.

Starting from this condition, the valve on conduit 19 is set in the open configuration and therefore the pourable product fills conduit 19 and bottom portion 18 of passage 14. The pourable product moves under the gravity action and/or under the effect of overpressure of tank 10 with respect to the ambient pressure and/or under the mechanical action of an agitator (known per se and not shown) housed within tank 10.

At this point, movable element 29 of actuator 27 is moved, to the second axial position so displacing shutter 22, coupled thereto, into the open configuration (FIG. 6). As a result, the pourable product flows through delivery mouth 15 and starts to fill bottle 2.

A known weighing system (not shown. in detail as not being part of the present invention) detects the amount of pourable product flowing into bottle 2 and, as a given value is reached, produces a stop filling signal, on the basis of which movable element 29 of actuator 27 is displaced into the first axial position so carrying head 25 of shutter 22 in the closing configuration on delivery mouth 15.

During production, all these steps are continuously repeated to fill a plurality of bottles 2.

At the end of production, a cleaning operation of filling unit 8 is performed.

Delivery mouth 15 is externally closed by a cover element 36 and movable element 29 of actuator 27 is displaced into the third axial position, in which it engages ring-shaped magnetic attraction element 35 (FIG. 7).

In this condition, actuator 27 is deactivated as movable element 29, together with shutter 22, is maintained in such position by attraction force exerted by magnetic attraction element 35 only.

Both fluidic lines 17 and 21 are fed with cleaning liquids, Le, a washing liquid, a sanitization liquid and a rinsing liquid, which flow along all parts to be cleaned. In particular, cleaning liquids flow between movable element 29 and tubular body 13 and between the latter and shutter 22; the presence of longitudinal gaps 40 as well as the conical shape of head 25 of shutter 22 ease the cleaning operation.

At the end of this step, actuator 27 is again activated to displace movable element 29 into the first axial position and shutter 22 into the closing configuration on delivery mouth 15 (FIG. 2). A new production step can he again started.

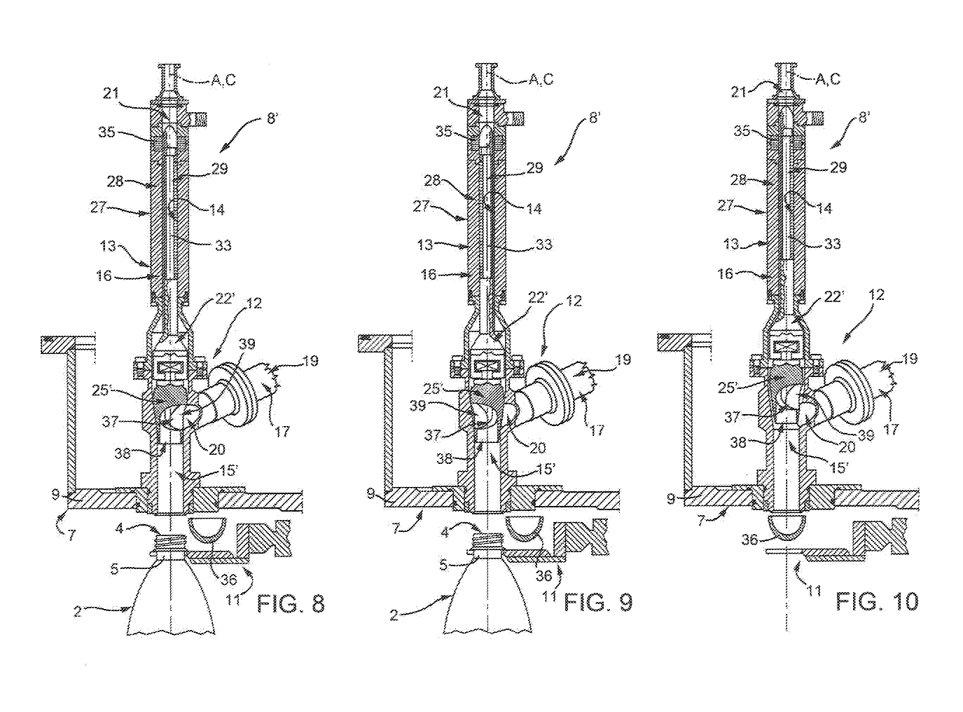

Number 8′ in FIGS. 8 to 10 indicates as a whole a different embodiment, of a filling unit in accordance with the present invention; filling units 8 and 8′ being similar to one another, the following description is limited to the differences between them, and using the same references, where possible, for identical or corresponding parts.

Filling unit 6′ differs from filling unit 8 basically in that it comprises a different type of shutter 22′ and in that the passage from the closing configuration to the opening configuration of shutter 22′ is achieved by rotating the same about its axis C.

In particular, shutter 22′ has a truncated-cone head 25′ cooperating in a fluid-tight manner with a complementary profile of delivery mouth 15′.

Shutter 22′ is internally provided with a elbow-shaped channel 37 defining a bottom opening 38, facing delivery mouth 15′, and a side opening 39, provided on one side of shutter 22′.

Shutter 22′ can be rotated by actuator 27 between an opening configuration (FIG. 8), in which elbow-shaped channel 37 has its side opening 39 communicating with conduit 19, and a closing configuration (FIG. 9), in which elbow-shaped channel 37 has its side opening 39 angularly spaced from hole 20 of conduit 19; in this latter position, the side surface of shutter 22′ closes hole 20 of lateral wall 16 of tubular body 13.

In particular, shutter 22′ is rigidly—i.e. axially and angularly—connected to movable element 29 so that any displacement of movable element 29 is directly transmitted to shutter 22′.

Actuator 27 is configured to both rotate and axially displace movable element 29 with respect to axis C; in particular, rotation of movable element 29 about axis C produces a corresponding rotation of shutter 22′ between the opening and the closing configuration; axial displacement of movable element 29 into the axial position or engagement of ring-shaped magnetic attraction element 35 is produced before starting the cleaning operation, in a completely equivalent manner to what is done with filling unit 8.

More specifically, as shown in FIGS. 3 and 9, shutter 22′ is axially fitted in a fluid-tight manner into delivery mouth 15′ in the different angular positions of movable element 29 to cut off flow from passage 14 of tubular body 13 to delivery mouth 15′.

The operation of filling unit 8′ completely identical to that of filling unit 8, except that movable element 29 and shutter 22′ are rotated about axis C, instead of being translated along the same axis, to define the opening and the closing configuration.

The advantages of filling units 8, 8′ and machine 1 according to the present invention will be clear from the foregoing description.

In particular, thanks to the use of magnetic attraction element 35, the cleaning operation of each filling unit 8, 8′ can be performed in a condition in which all actuators 27 are deactivated. This permits to significantly reduce costs and energy consumption as well as to avoid undesired overheating of the actuators 27.

In addition, the applicant has observed that the new solution makes unnecessary to provide additional cooling means to periodically cool actuators 27.

Clearly, changes may be made to filling units 1, 1′ and to machine 1 as described and illustrated herein without, however, departing from the scope as defined in the accompanying claims.

1. A filling unit for filling a container with a pourable product, the filling unit comprising:
a tubular body defining an axial passage for fluids and delimiting at one end a delivery mouth, through which the pourable product or at least one cleaning liquid flow in use;
a first fluidic line including the entire passage of the tubular body and fed in use with the at least one cleaning liquid;
a second fluidic line, which includes at least a portion of the passage of the tubular body terminating with the delivery mouth, and which is fed in use with the pourable product or with the at least one cleaning liquid;
a support device for supporting the container in a position below the delivery mouth;
a shutter housed within the passage and selectively moved to open or to close, in a fluid-tight manner, the delivery mouth; and
an actuator for moving the shutter:
wherein the actuator comprises an electromagnetic actuator having:
a stator fitted externally to the tubular body and provided with electrically-powered coils; and
a movable element carrying, at one end, the shutter, provided with at least one permanent magnet and coaxially housed inside the passage of the tubular body with a limited radial space to allow a fluid flow through the passage, the movable element being displaced by the stator into a first position, in which the movable element maintains said the shutter in a closing configuration on the delivery mouth, and into a second position, in which the movable element allows the pourable product or the cleaning liquid to flow through the delivery mouth,
wherein the filling unit further comprises a non-powered, ring-shaped, magnetic attraction element fitted to the tubular body in an axially-spaced relationship with the stator and exerting an attraction force on the movable element to maintain the movable element in a third position, distinct from the first position and the second position and corresponding to a position of the shutter being detached from the delivery mouth.

2. The filling unit as claimed in claim 1, wherein the second fluidic line is connected with the first fluidic line through a radial hole formed in a lateral wall of the tubular body, and wherein the portion of the passage is disposed between the hole and the delivery mouth.

3. The filling unit as claimed in claim 1, wherein the second fluidic line includes the entire passage of the tubular body.

4. The filling unit as claimed in claim 1, wherein the magnetic attraction element is made of a ferromagnetic material.

5. The filling unit as claimed in claim 1, wherein the magnetic attraction element includes a permanent magnet.

6. The filling unit as claimed in claim 1, wherein the first, second and third positions are distinct axial positions of the movable element within the passage.

7. The filling unit as claimed in claim 6, wherein the second position of the movable element corresponds to a position axially interposed between the first position and the third position.

8. The filling unit as claimed in claim 1, wherein the first and second positions are distinct angular positions of the movable element about an axis of the movable element; wherein the shutter is angularly coupled to the movable element and is axially fitted in a fluid-tight manner into the delivery mouth in the first and second angular positions of the movable element to cut off flow from the passage to the delivery mouth and wherein the shutter defines an internal channel having:
a first opening connected to the delivery mouth in both said the first and the second angular positions of the movable element; and
a second opening, which is connected to the second fluidic line, in the second angular position of the movable element to allow flow from the second fluidic line to the delivery mouth, and which is detached from the second fluidic line in the first angular position of said the movable element to cut off flow from the second fluidic line to the delivery mouth.

9. The filling unit as claimed in claim 1, wherein a plurality of angularly spaced longitudinal gaps are provided between the movable element and the tubular body

10. A filling machine for filling containers with a pourable product, comprising a plurality of filling units as claimed in claim 1.
